(19) United States
(12) Patent Application Publication
(10) Pub. No.: US 2016/0221307 A1
(43) Pub. Date: Aug. 4, 2016

(54) GLASS SURFACES FOR USE IN AIRCRAFT AND OTHER VEHICLES

(71) Applicant: Driessen Aerospace Group N.V., Alkmaar (NL)

(72) Inventors: Jochem Floris Wartena, Amsterdam (NL); Paul Cornelis Vlaming, Nibbixwoud (NL)

(21) Appl. No.: 14/993,489

(22) Filed: Jan. 12, 2016

Related U.S. Application Data
(60) Provisional application No. 62/102,661, filed on Jan. 13, 2015.

(51) Int. Cl. B32B 17/10; B64D 11/02; B64D 11/04

(52) U.S. Cl. CPC B32B 17/10; B32B 17/10137; B64D 11/04; B64D 11/02; B32B 2439/00; B32B 2451/00; B32B 2457/208; B32B 2605/18; B32B 2307/412

(57) ABSTRACT

Embodiments of the present invention provide a laminated glass surface for an aircraft or other passenger transportation vehicle surface. Specific features may include a glass substrate that is associated with an adhesive layer to form a laminated glass. The glass substrate may be an ultrathin glass substrate and/or a strengthened glass substrate. The laminated glass may then be secured to an aircraft surface.

### CROSS REFERENCE TO RELATED APPLICATIONS

This application claims the benefit of U.S. Provisional Application Ser. No. 62/102,661, filed Jan. 13, 2015, titled “Glass Applications,” the entire contents of which are hereby incorporated by reference.

### FIELD OF THE DISCLOSURE

Embodiments of the present disclosure relate generally to various uses of glass surfaces in passenger transportation vehicles. Particular embodiments find use in connection with aircraft cabins, and specifically, galleys, monuments, and lavatories. The glass surfaces can provide a protective surface, can improve the appearance of surfaces, and can improve cleanliness of surfaces.

### BACKGROUND

Passenger transportation vehicles often experience high passenger volume. For example, airlines carry hundreds of passengers over distances that are hundreds of miles, and they run routes many times a day. This volume brings catering requirements, particularly for long flights or travel times. This volume also brings other passenger comfort requirements.

Typically, aircraft galleys are not designed to be aesthetically pleasing. They are generally focused on utility and meeting Federal Aviation Administration (FAA), European Aviation Safety Agency (EASA), and Food and Drug Administration (FDA) requirements. In fact, the aesthetic possibilities for a galley work deck are limited due to food and health reasons. For example, painted work decks present a risk of paint chips flaking off into the food being prepared. Nonetheless, galleys are an area that many passengers view during boarding and while waiting for lavatory use. Galley work decks/countertops often experience dents and scratches. The work decks/countertops are often manufactured of aluminum, which is a lightweight material that is subject to easy damage. Some airlines may wish to present a cleaner and more elegant look to these areas.

Additionally, aircraft monuments also suffer over time from impact and scratching. Monuments are typically made out of panel materials that have a soft nature. Monument walls may also be subject to fingerprints, smearing, bumps, scratches, indentations, bacteria accumulation, and any number of other undesirable environmental challenges. Monument walls may also be manufactured with a non-smooth surface, such that the material has small bumps and ridges that can capture dirt. Some airlines may wish to present a cleaner and more elegant look to these areas as well.

Other aircraft surfaces may also experience wear, such as lavatory countertops, cabinets, and container surfaces. Virtually any aircraft or other vehicle surface may suffer over time from impact and scratching.

### BRIEF SUMMARY

Embodiments of the present invention provide a laminated glass surface for an aircraft or other passenger transportation vehicle surface. Specific features may include a glass substrate that is associated with an adhesive layer to form a laminated glass. The glass substrate may be an ultrathin glass substrate and/or a strengthened glass substrate. The laminated glass may then be secured to an aircraft surface.

In some examples, there is provided a laminated glass surface for an aircraft or other vehicle surface, comprising an ultrathin layer of glass; an adhesive layer; wherein the ultrathin layer of glass is laminated to the surface via the adhesive layer. In other examples, there is provided a glass surface for covering one or more aircraft surfaces, comprising a layer of strengthened glass; an adhesive layer; wherein the layer of strengthened glass is laminated to the aircraft surface via the adhesive layer. In either example, the adhesive layer may be a transparent sheet of adhesive.

The surfaces may be a galley countertop work surface, an aircraft monument wall, a decorative surface, wood, veneer, a painted surface, a printed pattern, a touch screen interface, an electrochromic material, or any combination thereof. The glass laminate can provide a protective covering to the surface. The glass laminate can provide a fire-resistance barrier on the surface.

The laminated glass surface may comprise one or more lighting elements. For example, the one or more lighting elements may display a status of one or more retainers.

### BRIEF DESCRIPTION OF THE DRAWINGS

FIG. 1 shows a monument wall with a laminated glass system secured thereto.

FIG. 2 shows the monument wall of FIG. 1, with the laminated glass system positioned over and protecting a touch screen interface, while allowing access thereto.

FIG. 3 shows a galley work surface with a laminated glass system secured thereto.

FIG. 4 shows a schematic of one embodiment of a laminated glass system.

FIG. 5A shows a galley work surface having a laminated glass surface that provides a side splash guard. FIG. 5B shows a galley work surface having a laminate glass surface and a drain system.

FIG. 6 shows a galley work surface having a laminated glass surface with a drain system.

FIG. 7 provides a flowchart of logic that may be used to control a lighting system used to detect a retainer position.

### DETAILED DESCRIPTION

Embodiments of the present invention provide a laminated glass surface for an aircraft surface. Glass is a generally scratch resistant material. However, glass is also prone to shattering upon impact because it is brittle. The present inventors have determined that using a glass laminate system allows its use in what would otherwise be considered an unacceptable environment for introducing a glass surface—passenger transportation vehicles. It should be understood that although the embodiments are described in this document with respect to use in an aircraft as the passenger transportation vehicle, it should be understood that this disclosure is equally usable applicable to other passenger transportation vehicles, such as trains, marine vessels (boats or cruise ships), RVs, or any other type of vehicle.

In one example, an aircraft surface may be covered with a laminate glass 12 as described herein. The aircraft surface may be a monument wall 14, a galley work surface 16, another countertop surface in the vehicle, any other aircraft surface, or any combination thereof.

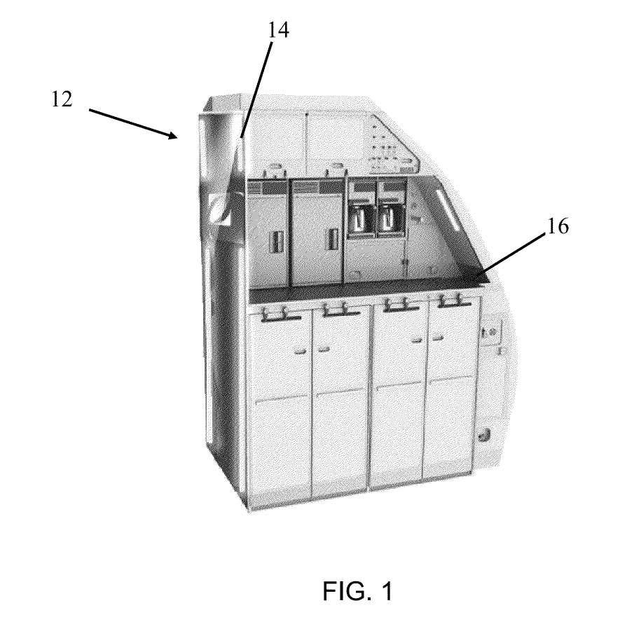

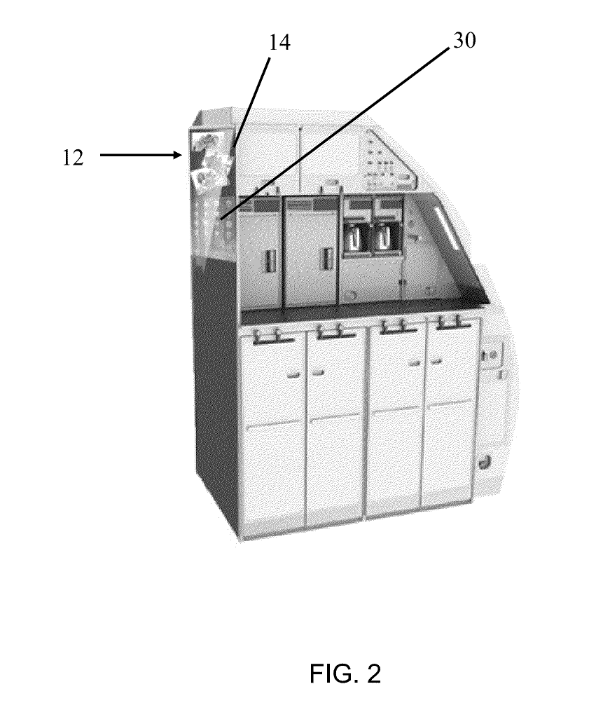

FIG. 1 illustrates a laminate glass surface 12 positioned on a monument wall 14. This laminate glass surface 12 may be an ultrathin glass surface or a strengthened glass surface, each of which are described in more detail below. FIG. 2 illustrates a laminate glass surface 12 positioned on a monument wall 14, over a touch interface or screen 30. The laminate glass surface 12 provides protection to the touch interface/screen 30, while also allowing use thereof. It is envisioned that an ultrathin glass surface may provide good access to a touch screen system. It is also possible to provide other types of touch controls, lighting, decorative surfaces, embedded photos or images, electrochromic materials, devices, or surfaces, or other branding materials protected by and otherwise covered by a laminate glass surface 12. In one example, the glass laminate 12 may provide a protective surface over an electrochromic device or cell. In another example, the glass laminate surface 12 may provide a protective layer over decorative surfaces such as wood, veneer, paint, printed patterns, or any other surface to be protected.

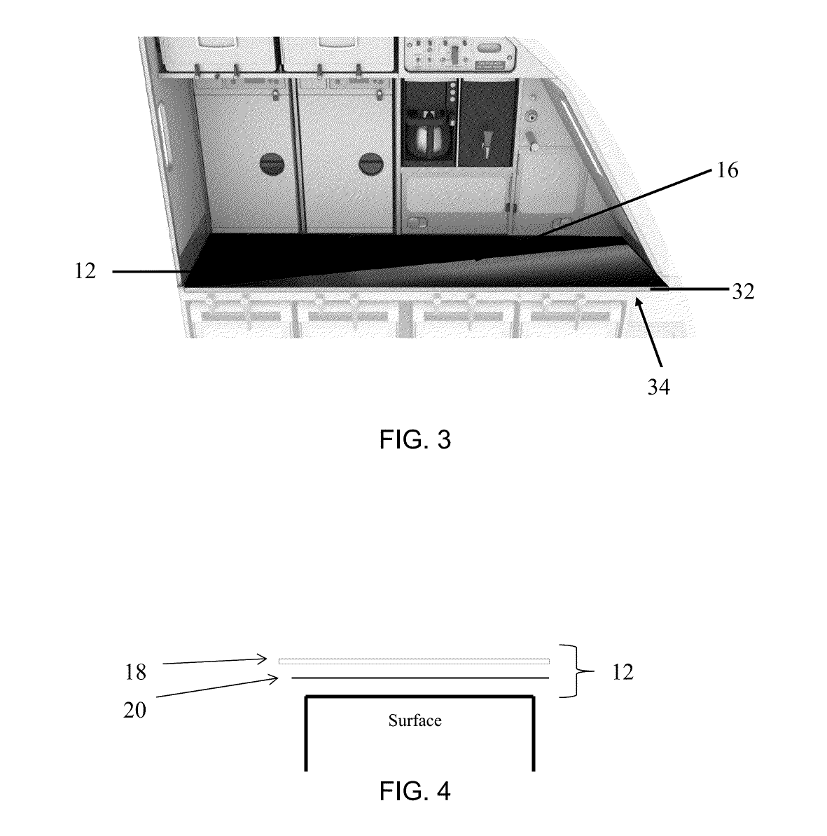

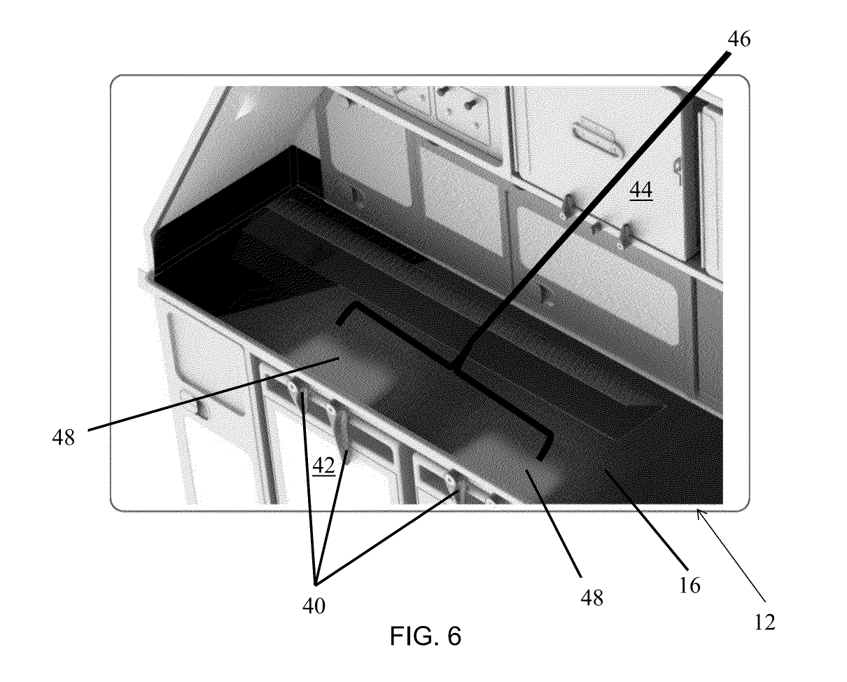

FIG. 3 illustrates a laminate glass surface 12 positioned on a galley work surface 16. This laminate glass surface 12 may be an ultrathin glass surface or a strengthened glass surface, each of which are described in more detail below. It is possible for the laminate glass surface 12 to be lit (such as backlit or side lit). Such lighting can allow the glass to form a light strip 32. The light strip 32 may be provided along a front edge 34 of the work surface 16. The lighting may be provided such that an entirety or majority of the work surface 16 is lit. The lighting may be provided such that only a portion of the work surface 16 is lit. In one example, the lighting may be used to indicate various statuses of items associated with the work surface, as described with respect to FIG. 6 further below. It is also possible for the laminate glass surface to cover one or more touch interfaces.

The transparent and scratch resistant nature of the glass provides a protective surface to the monument wall 14, the galley work surface 16, or any other surface. The glass laminate 12 is not penetrable by spills, stains, smears, fingerprint oils, or other undesirable sources of contact. The glass laminate 12 can be provided as a single layer over the surface, avoiding the presence of cracks or crevices that can harbor undesirable contact fluids or bacteria. This can also avoid the presence of gaps between various panels on a surface, such as a monument. One single cleaning swipe may be used to clean an entire surface. This can be more hygienic and can save aircraft turn-around time. The fire resistant nature of the glass laminate 12 may also enhance the fire resistance or non-flammability of the structure being covered. This fire-blocking can add an additional safety benefit.

In one example, the laminate glass 12 described herein may be manufactured from ultrathin glass. For example, the ultrathin glass may be as thin as a sheet of paper. In one example, the ultrathin layer of glass may be between about 25μ to about 500μ thick. In one example, the ultrathin layer of glass may be about 25-100μ thick. In another example, the ultrathin layer of glass may be about 100-200μ thick. In another example, the ultrathin layer of glass may be about 200μ thick. In another example, the ultrathin layer of glass may be about 200-500μ thick. In another example, the ultrathin layer of glass may be about 500μ thick. In another example, the ultrathin layer of glass may be about 1 mm thick. One example of ultrathin glass may be manufactured by Corning, of New York. For example, its Willow® Glass provides a thin and flexible glass substrate. This material is currently being used for smart phones, tablets, touch sensors, and other electronic devices. It has not been used as a surface cover for an aircraft or other vehicle surface. Other possible options for the ultrathin glass substrate include but are not limited to Schott AF32 eco or Schott D263 T eco, both manufactured by Scott Corp., of New York. It should be understood, however, that other alternatives or other types of ultrathin glass could be used and are considered within the scope of this disclosure.

Because an ultrathin layer of glass is so thin, it can easily be drilled into. If used to provide a surface for an aircraft monument panel, the manufacturing process of the panel, the monument, and the overall galley assembly need not be changed. The same rivets and fasteners that are used for galley assembly may be used on panels that have a glass laminate applied thereto without causing shattering of the glass substrate. Additionally or alternatively, surfaces that have had a polycarbonate mirror attached thereto may benefit from using the embodiments described herein.

The laminate glass 12 described herein may additionally or alternatively be a chemically strengthened glass. A chemically strengthened glass generally uses an ion exchange in order to make the glass more scratch resistant and stronger. One of ordinary skill in the art would understand this term, the related chemistry, and how to determine whether glass has been chemically strengthened, such that further description or details of the processes for manufacturing “strengthened glass” are not believed to be required. Chemically strengthened glass is usually slightly thicker than the ultrathin glass ranges provided above. In one example, the strengthened glass may be about 1-5 mm thick. In another example, the strengthened glass may be up to about 2-3 mm thick. One example of strengthened glass may Corning Gorilla glass, manufactured by Corning of New York. Other nonlimiting examples include but are not limited to Schott “Xensation,” manufactured by Schott Corp of, New York or Abrisa “Dragon tail,” manufactured by Abrisa Technologies, of Santa Paula, Calif. It should be understood, however, that other alternatives or other types of strengthened glass could be used and are considered within the scope of this disclosure.

In some examples, the strengthened glass may be a thicker layer of glass, and may provide a thicker strengthened glass laminate (as compared to an ultrathin glass substrate). This example may thus find particular use in connection with an aircraft galley. Aircraft galley surfaces experience a number of impacts, and the strengthened glass laminate can provide more impact resistance, a stronger surface, and an easier to clean surface.

In either instance, a glass substrate 18 is generally associated with an adhesive layer 20 in order to form the laminate glass 12. The adhesive layer 20 may be a transparent laminate sheet of adhesive. It may be a pressure sensitive adhesive, a heat activated adhesive, or any other appropriate adhesive. In one example, it may be desirable that the adhesive be a transparent adhesive, such that the resulting laminate glass surface 22 has a transparent appearance. In another example, the adhesive may be a colored adhesive in order to provide a colored appearance to laminate glass surface 22. It is possible for any appropriate adhesive to be used, non-limiting examples of which include but are not limited to 3M thin sheet adhesives. Specific adhesive examples that may be used include 3M 8212 or 3M 8215 thin sheet adhesives. However, these are examples only. It is also possible to use a glue-based and/or liquid adhesive that is painted onto the surface and/or the substrate. In one example, the adhesive layer 20 may be a double-sided adhesive, such that a first side of the adhesive is secured to the glass substrate and a second side of the adhesive is secured to the surface. In another example, the adhesive layer 20 may be applied directly to the surface and the ultrathin glass may be applied thereto. In another example, once the glass substrate has been formed, it may be secured to an aircraft surface, such as a monument, using fasteners or other mechanical means.

By using an adhesive layer 20 to secure the ultrathin glass to a surface, a laminate glass 12 is provided. The laminate glass 12 has been found to strengthen the surface, without adding substantial weight to the vehicle. Additionally, if the surface does experience an impact, it has been found that the adhesive layer 20 prevents spreading of shattered shards of the glass substrate. Instead, even if the glass substrate 18 may break of shatter, broken glass portions remain in place due to the adhesive layer 20.

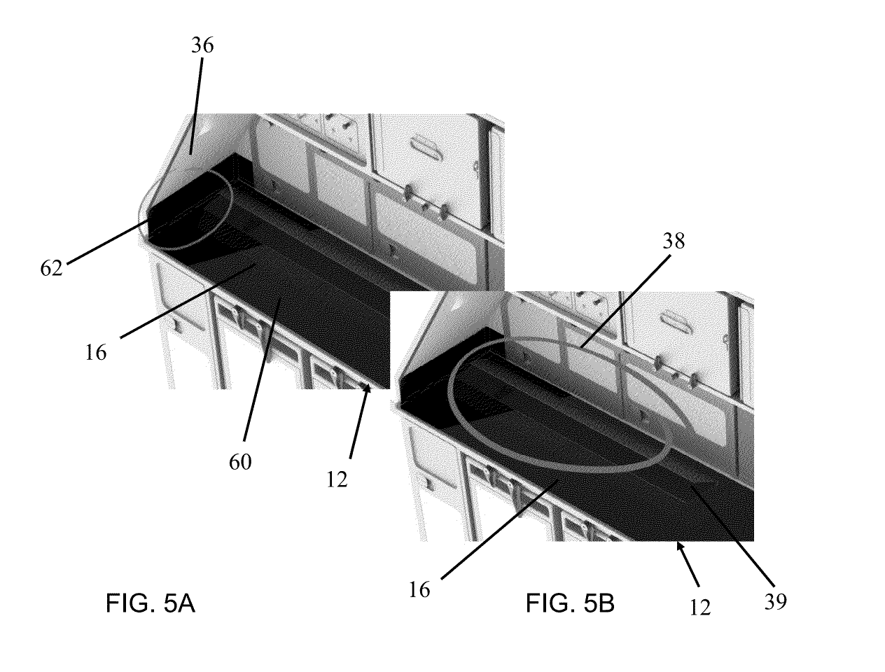

FIG. 5A illustrates a laminate glass surface 12 positioned on a galley work surface 16 and extending up at least a portion of a sidewall 36. This embodiment may find particular use with ultrathin glass, which is bendable and is shapeable. One benefit of this configuration is that a portion of the glass laminate 12 may be bent to travel in the vertical dimension 62 as well as the horizontal dimension 60. This can provide a splash guard for the sidewall 36. The ultrathin glass substrate used may be a single piece.

FIG. 5B illustrates a galley work surface 16 having a laminate glass surface 12. The work surface 16 also has a drain system 38. The drain system 38 may include an integrated rear drain 39, as shown. In another example, the drain system 38 may include one or more drains positioned at various points along the work surface 16. In another example, the drain system 38 may include one or more side drains positioned along a side of the work surface 16.

FIG. 6 illustrates a galley work surface 16 having a laminate glass surface 12 that is back lit. In one example, the lighting may correspond to the various feedback positions. In one example, the lighting may relay information about the position of one or more retainers 40. As background, in use, retainers 40 are used to secure trolleys 42 in place underneath the work surface 16. Retainers 40 are also used to secure storage containers 44 in place above the work surface 16. These items must be secured during takeoff and landing and at other potentially turbulent times during flight. The retainers 40 must be fully locked and closed in order to ensure securement. However, there may be instances when one or more attendants do not fully close the retainers 40. It is thus possible to provide a lighting system 46 that indicates the position of one or more retainers 40. For example, if a retainer 40 is fully closed, the lighting system 46 may glow green in the indicator area 48. However, if a retainer 40 is not fully close or otherwise in the open position, the lighting system 46 may glow red in the indicator area 48.

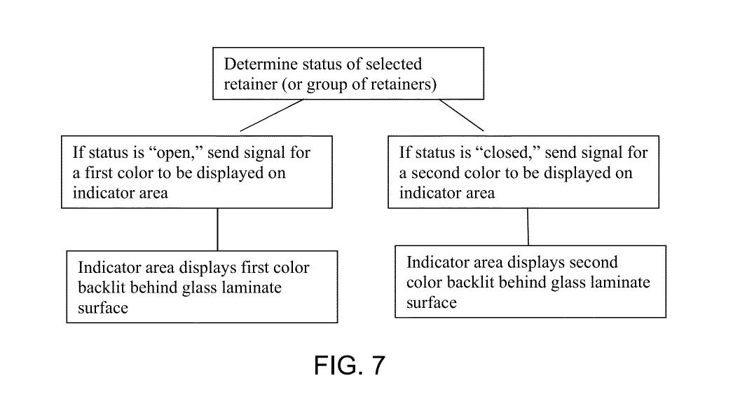

A sensing and lighting system may be provide in order to detect positions of one or more retainers 40 and to deliver the appropriate backlit color (or other visual indicator) to the indicator area. For example, as illustrated by the flowchart of FIG. 7, a sensing system may determine the status of one or more retainers. These may be retainers for trolleys, storage compartments, or any other appropriate aircraft locking system features. The detection may be via magnetic conduction, a magnetic read contact system, electrical sensing, a weight sensor, or any other appropriate detecting system. Once the status of the retainer is determined, a signal for an appropriate color to be displayed in the indicator area may be sent to the lighting system. The appropriate color light may be backlit behind, underneath, along an edge, or anywhere appropriate with respect to the laminate glass surface 12. In use, an attendant can easily glance at the glass laminate surface 12 and quickly determine whether one or more retainers are in the open position. This can save time for conducting safety checks, and it can also function as a useful back-up safety features.

Changes and modifications, additions and deletions may be made to the structures and methods recited above and shown in the drawings without departing from the scope or spirit of the disclosure or the following claims.

What is claimed is:

1. A laminated glass surface for an aircraft or other vehicle surface, comprising:
an ultrathin layer of glass;
an adhesive layer;
wherein the ultrathin layer of glass is laminated to the surface via the adhesive layer.

2. The surface of claim 1, wherein adhesive layer comprises a transparent sheet of adhesive.

3. The surface of claim 1, wherein the ultrathin layer of glass is less than about 2 millimeters thick.

4. The surface of claim 1, wherein the ultrathin layer of glass is less than about 500 microns thick.

5. The surface of claim 1, wherein the ultrathin layer of glass is as thin as about 25 microns.

6. The surface of claim 1, wherein the ultrathin layer of glass comprises strengthened glass.

7. The surface of claim 1, wherein the aircraft surface comprises a galley countertop work surface.

8. The surface of claim 1, wherein the aircraft surface comprises an aircraft monument wall.

9. The surface of claim 1, wherein the aircraft surface comprises a decorative surface, wood, veneer, a painted surface, a printed pattern, a touch screen interface, an electrochromic material, or any combination thereof, and wherein the glass laminate provides a protective covering to the surface.

10. The surface of claim 1, wherein the laminated glass surface comprises one or more lighting elements.

11. The surface of claim 10, wherein the one or more lighting elements display a status of one or more retainers.

12. The surface of claim 1, wherein the laminated glass provides a layer covering a horizontal surface and bends to further cover a vertical surface.

13. The surface of claim 1, wherein the laminated glass provides a splash guard.

14. The surface of claim 1, wherein the laminated glass further comprises a drain system.

15. The surface of claim 1, wherein the laminated glass provides fire-resistance to the surface.

16. A glass surface for covering one or more aircraft surfaces, comprising:
a layer of strengthened glass;
an adhesive layer;
wherein the layer of strengthened glass is laminated to the aircraft surface via the adhesive layer.

17. The surface of claim 16, wherein the strengthened glass is about 1-5 millimeters thick.

18. The surface of claim 16, wherein the aircraft surface comprises a galley countertop work surface.

19. The surface of claim 16, wherein the laminated glass surface comprises one or more lighting elements.

20. The surface of claim 19, wherein the one or more lighting elements display a status of one or more retainers.

21. The surface of claim 16, wherein the laminated glass further comprises a drain system.
